(19) United States
(12) Patent Application Publication
(10) Pub. No.: US 2004/0252764 A1
(43) Pub. Date: Dec. 16, 2004

(54) Motion vector generation apparatus and method

(76) Inventors: Bong-soo Hur, Suwon-si (KR); Oh-jae Kwon, Anyang-si (KR); Sung-hee Lee, Suwon-si (KR)

Correspondence Address: STANZIONE & KIM, LLP, 1740 N STREET, N.W., FIRST FLOOR, WASHINGTON, DC, 20036, US

(21) Appl. No.: 10/854,219

(22) Filed: May 27, 2004

(30) Foreign Application Priority Data
Jun. 16, 2003 (KR) 2003-38794

(51) Int. Cl. H04N 7/12

(52) U.S. Cl. 375/240.16; 375/240.12; 375/240.24

(57) ABSTRACT

A motion vector generation apparatus, and a method thereof. In the apparatus, a weight calculation part can adaptively calculate a predetermined weight corresponding to at least one of respective inputted candidate motion vectors, and a final motion vector calculation part can adaptively generate a final motion vector by applying the calculated predetermined weight to at least one of the corresponding candidate motion vectors. The generated final motion vector is used for motion compensation of the current block to be interpolated. Therefore, block artifacts can be prevented by estimating a plurality of motion vectors for motion compensation and adaptively applying the weight to the estimated motion vectors.

### CROSS-REFERENCE TO RELATED APPLICATIONS

This application claims the benefit of Korean Application No. 2003-38794, filed Jun. 16, 2003, in the Korean Intellectual Property Office, the disclosure of which is incorporated herein by reference.

### BACKGROUND OF THE INVENTION

1. Field of the Invention

The present invention relates to a motion vector generation apparatus and a method thereof, and more particularly, to a motion generation apparatus that estimates a plurality of candidate motion vectors per block, and performs motion compensation by applying a weight to the estimated motion vector, and a method thereof.

2. Description of the Related Art

Generally, in a PC or an HDTV, frame rate conversion is performed to exchange programs having various broadcasting signal specifications such as PAL or NTSC. The frame rate conversion refers to converting of the number of frames output per minute. Especially, when the frame rate increases, a process of interpolating a new frame is required.

Meanwhile, as broadcasting technology has developed recently, the frame rate conversion is performed after compressing an image data by an image data compressing method such as moving picture experts group (MPEG) and H.263. Especially, in a field of the image processing, an image signal usually has redundancy due to the high autocorrelation. Therefore, by removing the redundancy while compressing the data, efficiency of data compression can be improved. Here, for effective compression of a video frame which varies according to time, the redundancy in the time-axis direction should be removed.

The removal of the redundancy in the time-axis direction is based on a concept that an amount of data to be transferred is greatly reduced by replacing unchanged portions or moved-but-still-similar portions in a current frame with corresponding portions in an immediately preceding frame.

To make the replacement, it is necessary to find the most similar block between the current frame and the reference frame, which is called “motion estimation.” An indication of an amount of displacement of the block is called a “motion vector.”

One of typical methods for estimating motion vectors is a block matching algorithm (BMA). The BMA is generally used in consideration of precision, real-time processing ability, and hardware implementation and the like.

FIG. 1 is a drawing illustrating a method of estimating motion vectors using a general conventional BMA.

Referring to FIG. 1, Fₙ₋₁ is a previous frame/field, Fₙ is a current frame/field, Fᵢ is a frame to be interpolated using the previous frame/field (Fₙ₋₁) and the current frame/field (Fₙ).

The Block Matching Algorithm compares two consecutive images such as the previous frame/field and the current frame/field by block units, and estimates one motion vector per block assuming that the pixels in the compared blocks perform a translation. At this time, the motion vector is estimated using a well-known SAD (Sum of Absolute Difference). When the motion vector is estimated, motion compensation is performed with respect to the current block (B) to be interpolated using the estimated motion vectors (MV).

However, the conventional method for estimating/compensating the motion may cause an inaccurate estimation of respective motion vectors which are estimated by blocks. If the motion compensation is performed with the inaccurate motion vectors, block artifacts occur in the interpolation frame/field (Fᵢ), as shown in FIG. 2A. The block artifacts can be illustrated with a motion vector field, as shown in FIG. 2B. In FIG. 2A, a solid line is a true motion vector, and a dotted line is an estimated motion vector.

Referring to FIG. 2B, an oval in solid line represents an object which has moved a predetermined distance from an oval in dotted line, and arrows represent motion vectors. When a motion vector of a current block to be interpolated is inaccurately estimated, the current block motion vector (MV) and the motion vectors estimated per respective peripheral blocks (not shown) may become inconsistent, and accordingly, a visually inferior image such as block artifacts is provided. Such an inaccurate estimation of a motion vector frequently occurs in an occlusion area where a background area and an objection moving direction do not correspond, or in a noise area, for instance.

In addition, a conventional motion estimation/compensation method may employ a nonlinear filter, such as a median filter, to the estimated motion vector (MV) to remove the block artifacts. However, the nonlinear filter is not remarkably effective to improve quality of an image in the occlusion area.

### SUMMARY OF THE INVENTION

It is an aspect of the present general inventive concept to provide a motion vector generation apparatus that prevents block artifacts from occurring by the motion compensation using inaccurately estimated motion vectors, and a method thereof.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing a motion vector generation apparatus including a weight calculation part to adaptively calculate a predetermined weight to apply to at least one of respective candidate motion vectors which are estimated to compensate a current block to be interpolated, and a final motion vector calculation part to adaptively generate a final motion vector by allocating the calculated weight to at least one of the candidate motion vectors corresponding to the calculated weight, wherein the generated final motion vector is used for motion compensation of the current block.

q In greater detail, at least one of the candidate motion vectors may include a motion vector estimated from the current block and motion vectors estimated from at least one of peripheral blocks adjacent to the current block.

Further, the weight calculation part can determine the accuracy of the estimated candidate motion vectors by comparing final motion prediction errors corresponding to the respective candidate motion vectors, and can calculate the weight to allocate to the candidate motion vectors according to the accuracy as determined, and at least one of the candidate motion vectors can be a vector estimated from a position corresponding to the minimum value among a plurality of motion prediction errors calculated by applying a block matching algorithm with respect to the current block and the respective peripheral blocks.

The weight is inversely proportional to the final motion prediction error calculated with respect to the current block and the respective peripheral blocks. The motion prediction error is calculated by at least one of sum of absolute difference (SAD).

The sum of the weights corresponding to the respective candidate motion vectors calculated from the weight calculation part is 1.

The final motion vector calculation part can calculate the final motion vector according to the following Equation:

$${v}^{′} = {\sum }_{i = 0}^{M} {w}_{i} {v}_{i}$$

where vᵢ is the at least one candidate motion vector, wᵢ is a weight applied to vᵢ, and v′ is the final motion vector.

The motion vector generation apparatus may further include a reliability determination part that can calculate a reliability to determine whether the respective candidate motion vectors are used during generation of the final motion vector, and to provide a selective signal to the weight calculation part, the selective signal which enables only a predetermined candidate motion vector which has the reliability larger than a preset threshold, among the at least one candidate motion vector to be applied with the weight.

In addition, the reliability can be calculated by the following Equation:

|Φ(ν_{z})−Φ(νᵢ)|<ε_{T}, i=0, 1, 2, . . . , M

where Φ(ν_{z}) is a motion prediction error corresponding to the zero motion vector, Φ(νᵢ) is a motion prediction error corresponding to the candidate motion vectors, and ε_{T} is the threshold.

The foregoing and/or other aspects of the present general inventive concept may also be achieved by providing a method of generating a motion vector, the method including adaptively calculating a predetermined weight to allocate to at least one candidate motion vector, respectively, for compensation of the current block to be interpolated, and adaptively generating a final motion vector by allocating the calculated weight to at least one of the candidate motion vectors corresponding to the calculated weight, wherein the generated final motion vector is used for motion compensation of the current block.

The weight calculating operation can determine the accuracy of the estimated candidate motion vectors by comparing final motion prediction errors corresponding to the respective candidate motion vectors, and can calculate the weight to allocate to the candidate motion vectors according to the accuracy as determined, and at least one of the candidate motion vectors is a vector estimated from a position corresponding to the minimum value among a plurality of motion prediction errors calculated by applying a block matching algorithm with respect to the current block and the respective peripheral blocks.

The method may further include a reliability calculating operation that determines whether the respective candidate motion vectors are used during generation of the final motion vector, and that provides a selective signal to the weight calculation part, the selective signal which enables only a predetermined candidate motion vector which has the reliability larger than a preset threshold, among the at least one candidate motion vector to be applied with the weight.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a drawing illustrating a method of estimating motion vectors using a general block matching algorithm;

FIG. 2A is an examplary simulation of an image where block artifacts occur by a general method of motion compensation;

FIG. 2B is a drawing illustrating a motion vector field estimated in an occlusion area where the block artifacts of FIG. 2A occur;

FIG. 3 is a block diagram schematically illustrating a motion compensation apparatus using a motion vector according to an embodiment of the present invention;

FIG. 4A is a drawing illustrating a current block and peripheral blocks set for the motion estimation in a motion estimation part of FIG. 3;

FIG. 4B is a drawing illustrating the motion vectors of the current block and peripheral blocks, estimated by unidirectional BMA in the motion estimation part of FIG. 3;

FIG. 4C is a drawing illustrating the motion vectors of the current block and peripheral blocks estimated by bidirectional estimation in the motion estimation part of FIG. 3;

FIG. 5 is an examplary simulation of an image where the block artifacts are removed by the motion compensation apparatus of FIG. 3; and

FIG. 6 is a flowchart schematically illustrating the motion compensation method as shown in FIG. 3.

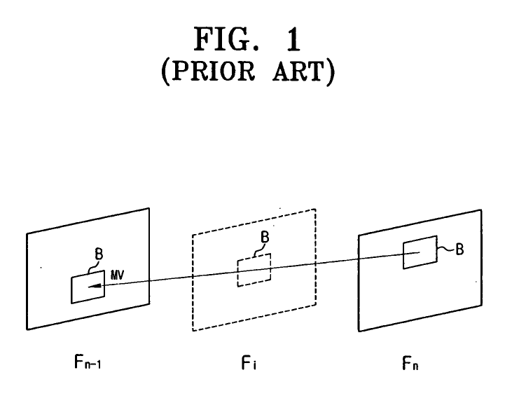

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

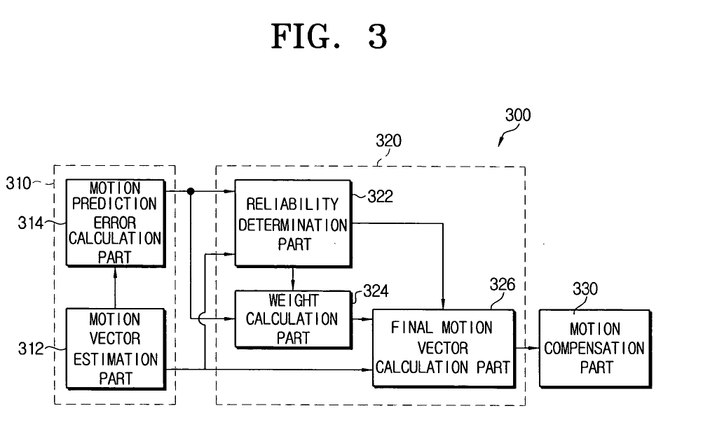

FIG. 3 is a block diagram schematically showing a motion compensation apparatus using motion vectors according to an embodiment of the present general inventive concept.

Referring to FIG. 3, a motion compensation apparatus 300 using motion vectors according to an embodiment of the general inventive concept includes a motion estimation part 310, a final motion vector generation part 320, and a motion compensation part 330.

The general inventive concept relates to a motion compensation by estimating a plurality of motion vectors, and will be described only with reference to blocks that are related to the motion estimation/compensation.

The motion estimation part 310 can estimate motion vectors between a current frame/field (Fₙ) and a previous frame/field (Fₙ₋₁) using a block matching algorithm (BMA). Here, the previous frame/field (Fₙ₋₁) and the current frame/field (Fₙ) are inputted consecutively.

Meanwhile, in case that the motion compensation apparatus 300 according to FIG. 3 converts a frame rate of an image which is inputted by interlacing, it is an aspect here that the current frame/field (Fₙ) and the previous frame/field (Fₙ₋₁) are inputted by a field unit.

The motion estimation part 310 may include a motion vector estimation part 312 and a motion prediction error calculation part 314.

The motion vector estimation part 312 can divide the current frame/field (Fₙ) into blocks of a predetermined size to be interpolated, and can calculate a plurality of motion prediction errors with respect to the respective blocks, by respectively matching in one direction the divided blocks with a plurality of blocks of the previous frame/field (Fₙ₋₁).

More specifically, the motion vector estimation part 312 can set up a predetermined searching range S in the current frame/field (Fₙ) which is divided into blocks of a predetermined size. Further, the motion vector estimation part 312 can calculate a plurality of motion prediction errors with respect to the respective blocks by matching in one direction the blocks in the searching range with a plurality of blocks (not shown) of the previous frame/field (Fₙ₋₁) respectively.

The motion prediction error can be calculated by a variety of methods such as SAD, MAD (Mean Absolute Difference) and the like. The SAD method is employed as an example in this embodiment.

When a plurality of SADs are calculated with respect to the respective blocks to be interpolated, the motion vector estimation part 312 can estimate the motion vectors of the respective blocks, using an Equation 1 below.

[Equation 1]

ν=arg min_{νεS}{Φ(ν)}

Referring to Equation 1, Φ(v) is an SAD, v is a motion vector of a block having a minimum SAD (from now on, ‘v’ means vector), and S is the searching range. That is, the motion vector estimation part 312 can estimate the motion vectors of the respective blocks to be interpolated starting from a position having the minimum SAD among a plurality of SADs calculated for the blocks to be interpolated.

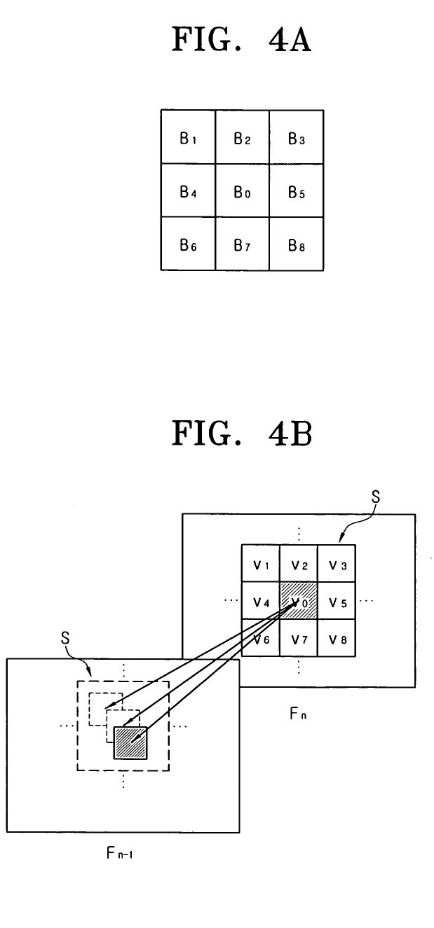

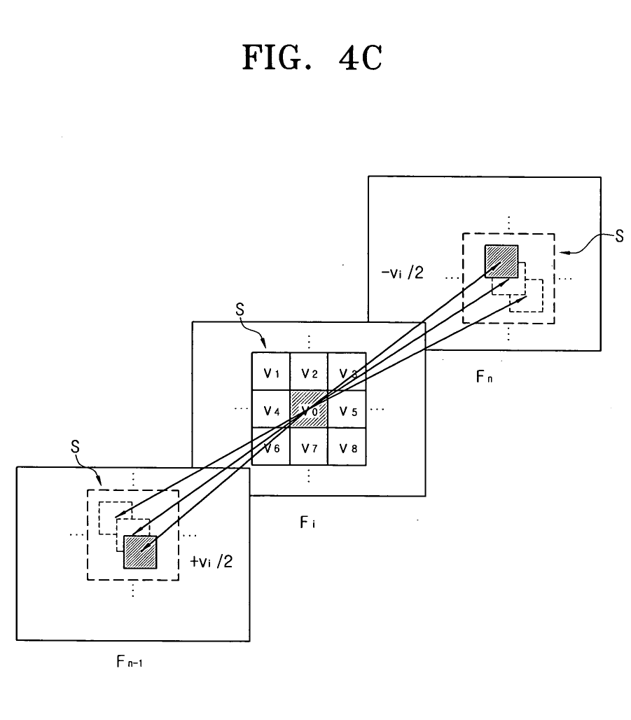

Referring to FIGS. 4A and 4B, when the motion vector estimation part 312 sets up the predetermined searching range S based on the current block B₀ to be interpolated, as shown in FIG. 4A, blocks B₁ to B₈ are peripheral blocks adjacent to the current block B₀ in the searching range S. Further, when the motion vector of the current block B₀ is v₀, the motion vectors of the peripheral blocks B₁ to B₈ are v₁ to v₈, respectively.

Meanwhile, the searching range S, being set up in the current frame/field Fₙ, represents an area for interpolation in the interpolation frame/field Fᵢ. The number of blocks existing in the searching range S can be set up variously according to the size of the blocks and/or the searching range S.

Further, the motion vector estimation part 312 can estimate a zero motion vector of the current block B₀.

Further, the motion vector estimation part 312 can provide the motion vectors v₀ to v₈ of the respective blocks B₀ to B₈ existing in the searching range S, and the zero motion vector v_{z}, that is, the motion vector of the current block B₀ is zero, to the motion prediction error calculation part 314.

The motion predict error calculating part 314 can calculate the SAD corresponding to the motion vectors v_{z}, v₀ to v₈ provided by the motion vector estimation part 312, using an Equation 2 below.

$$Φ ( {v}_{i} ) = {\sum }_{x ∈ B} \vert f ( x + {v}_{i} , n - 1 ) - f ( x , n ) \vert , \\ i = 0 , 1 , 2 , … , M \qquad [ Equation 2 ]$$

Here, Φ(νᵢ) is the SAD corresponding to the respective motion vectors v₀ to v₈, x is a vector as the coordinate data of a predetermined pixel located in a predetermined block which is one of B₀ to B₈, vᵢ is motion vectors v₀ to v₈ of the respective blocks B₀ to B₈, n is temporal intervals between the previous frame/field (Fₙ₋₁) and the current frame/field (Fₙ), and M is the number of the respective blocks B₀ to B₈ existing in the searching range S. In addition, the motion prediction error calculation part 314 can calculate the SAD with respect to the zero motion vector v_{z} of the current block B₀, using the Equation 2.

Referring to Equation 2, the motion prediction error calculation part 314 extracts the SAD corresponding to the motion vectors v₁ to v₈ of the respective peripheral blocks B₁ to B₈ and the zero motion vector v_{z}, respectively, among all the SAD calculated with respect to the current block B₀. That is, the motion vectors v_{z}, v₀ to v₈, which are provided by the motion vector estimation part 312 are applied as candidate motion vectors of the current block B₀ to be interpolated.

This is to do motion compensation more accurately when the motion vector v₀ of the current block B₀ is inaccurately estimated, by replacing motion vectors of better-estimated blocks among the peripheral blocks B₁ to B₈, i.e., a block having the minimum SAD, with the final motion vector of the current block B₀, or performing the motion compensation more correctly by applying a weight to the better-estimated peripheral blocks B₁ to B₈.

That is, the motion compensation according to this embodiment is performed considering the motion trajectories of the peripheral blocks B₁ to B₈ as well as the current block B₀, assuming that motions between the blocks B₀ to B₈ are smooth. This is to prevent the block artifacts caused when the motion vector v₀ of the current block B₀ is inaccurately estimated.

When the SADs corresponding to the respective candidate motion vectors v_{z}, v₀ to v₈ are calculated, the motion prediction error calculation part 314 can provide the respectively calculated SADs to a reliability determination part 322 and a weight calculation part 324.

Further, the motion vectors v_{z}, v₀ to v₈ of the respective blocks B₀ to B₈ estimated from the motion vector estimation part 312, or with the motion vectors (not shown) estimated with respect to all the divided blocks (not shown) are provided to the reliability determination part 322 and the weight calculation part 324.

The motion estimation part 310 can estimate the motion vectors v_{z}, v₀ to v₈ of the current block B₀ and the peripheral blocks B₁ to B₈ estimated by a two-direction BMA, as shown in FIG. 4C, as well as by the one-direction BMA, as shown in FIG. 4B. The description regarding this is omitted as a well-known art.

In addition, for the motion vectors of the current block B₀, not only the motion vector v₁ to v₈ with respect to the peripheral blocks B₁ to B₈, but also the motion vectors estimated in the global motion vector detected during a motion analysis process (not shown) and the previous frame/field of the same position, can be reused.

Referring again to FIG. 3, the final motion vector generation part 320 applied to a motion vector generating device according to this embodiment can generate the final motion vector of the current block B₀, using a plurality of SAD and the candidate motion vectors provided by the motion estimation part 310. For this, the final motion vector generation part 320 can include the reliability determination part 322, the weight calculation part 324, and a final motion vector calculation part 326.

The reliability determination part 322 can determine reliability with respect to the candidate motion vectors among the plurality of the motion vectors v_{z}, v₀ to v₈ estimated from the motion vector estimation part 312. The reliability determination part 322 can provide a certain selective signal to the weight calculation part 324 according to the estimation result wherein, the selective signal enables only motion vectors of superior reliability to be applied with the weight, among the candidate motion vectors v_{z}, v₀ to v₈. The ‘reliability’ in this specification refers to a value to determine whether the respective motion vectors v_{z}, v₀ to v₈ will be used when generating the final motion vector that will be described later.

For this, the reliability determination part 322 is supplied with the motion vectors v_{z}, v₀ to v₈ of the respective blocks B₀ to B₈ estimated from the motion vector estimation part 312, and SAD corresponding to the motion vectors v_{z}, v₀ to v₈ of the respective blocks B₀ to B₈, calculated from the motion prediction error calculation part 314.

The reliability determination part 322 can determine the reliability with respect to the respective motion vectors v₀ to v₈, using an Equation 3 below.

[Equation 3]

|Φ(ν_{z})−Φ(νᵢ)|<ε_{T}, i=0, 1, 2, . . . , M

Referring to Equation 3, ε_{T} is a threshold set to determine the reliability of the estimated motion vector, Φ(ν_{z}) is an SAD corresponding to the zero motion vector v_{z}, Φ(νᵢ) is an SAD corresponding to the estimated motion vectors v₀ to v₈, and (Φ(ν_{z})−Φ(νᵢ)) is the reliability of the estimated respective motion vectors v₀ to v₈.

Referring to Equation 3, the reliability determination part 322 can compare the reliability with the preset threshold, and can supply the selective signal to the weight calculation part 324, wherein the selective signal enables only motion vectors having reliability greater than the preset threshold to be applied with the weight, among the estimated motion vectors v₀ to v₈.

To describe in detail, the reliability determination part 322 can determine a motion vector, such as v₁ among the estimated motion vectors v₀ to v₈, to be estimated accurately when the motion vector does not correspond to Equation 3. Then the reliability determination part 322 can provide a selective signal ‘1’ to the weight calculation part 324, to apply a predetermined weight to the motion vector such as v₁ which does not correspond to Equation 3.

On the other hand, the reliability determination part 322 determines a motion vector such as v₂ among the estimated motion vectors v₀ to v₈ to be estimated inaccurately when the motion vector corresponds to Equation 3. In this case, the reliability determination part 332 provides a selective signal ‘0’ to the weight calculation part 324, so that a predetermined weight is not applied to the motion vector such as v₂ which corresponds to Equation 3.

Further, the reliability determination part 322 can determine a motion vector such as v₂ among the estimated motion vectors v₀ to v₈ to be a motion vector estimated in a flat image when the motion vector corresponds to Equation 3, and the reliability determination part 322 can perceive it as a zero motion vector v_{z}. Accordingly, motion compensation with respect to a predetermined motion vector which corresponds to Equation 3, such as v₂, is performed by temporal averaging. This is because it is more accurate to perform the motion compensation by the temporal averaging, regardless of the motions, than estimating the motion vector by the BMA, in case that there are complicated motions rather than a translation motion. Here, the flat image may include images without an edge area or a high frequency component.

The weight calculation part 324 considers accuracy in the respective motion trajectories using the SAD corresponding to the zero motion vector v_{z} of the current block B₀, the SAD corresponding to the respective motion vectors v₀ to v₈ supplied from the motion prediction error calculation part 314, and a reliability selective signal with respect to the respective motion vectors v_{z}, v₀ to v₈ supplied from the reliability determination part 322, and then can calculate the weight to apply to the respective motion vectors v_{z}, v₀ to v₈. Here, the accuracy of the motion vectors v₀ to v₈ represents how correctly the motion vectors v₀ to v₈ are estimated. The accuracy of the motion vectors is determined according to the SAD.

That is, the weight calculation part 324 does not apply the weight to motion trajectories having an SAD corresponding to the selective signal ‘0’, but can apply the weight to a motion vector having an SAD corresponding to the selective signal ‘1’ adaptively, according to the SAD.

The weight calculation part 324 can calculate a weight to apply to the zero motion vector v_{z} of the current block B₀ and motion vectors v₀ to v₈ of the respective blocks B₀ to B₈ using an Equation 4 below.

$${w}_{i} = \frac{1 / Φ ( {v}_{i} )}{{\sum }_{j = 0}^{M} 1 / Φ ( {v}_{j} )} , i = 0 , 1 , … , M \qquad [ Equation 4 ]$$

Here, vᵢ is the motion vectors v₀ to v₈ of the current and the peripheral blocks B₀, B₁ to B₈, and wᵢ should satisfy an Equation 5 below.

$${\sum }_{i = 0}^{M} {w}_{i} = 1 \qquad [ Equation 5 ]$$

Referring to Equation 4 and Equation 5, the weight to be applied to the respective motion vectors v_{z}, v₀ to v₈, which is calculated from the weight calculation part 324, is inversely proportional to the SAD corresponding to the respective motion vectors v_{z}, v₀ to v₈.

That is, the weight calculation part 324 can compare the SAD corresponding to the respective motion vectors v₀ to v₈ of the blocks B₀ to B₈, can determine that the smaller the SAD is, the more correctly the motion compensation is performed, and can calculate the weight which is inversely proportional to the SAD. In other words, the accuracy in the respective motion vectors v_{z}, v₀ to v₈ is determined, depending on the SAD of the respective blocks B₀ to B₈.

For instance, when two selective signals ‘1’ are inputted from the reliability determination part 322 to apply the weight to two motion vectors, i.e., v₀ and v₂, of the respective motion vectors v₀ to v₈, the weight calculation part 324 can calculate the weight to apply to the motion vectors corresponding to the inputted selective signal ‘1’, such as v₀ and v₂, with the larger weight being applied to a motion vector having the smaller SAD. For example, one of v₀ and v₂ is applied with a larger weight. The weights with respect to the two motion vectors such as v₀ and v₂ are applied to the final motion vector calculation part 326. The sum of the weights applied to the motion vectors such as v₀ and v₂ corresponding to the two SAD is ‘1’ according to Equation 5.

The final motion vector calculation part 326 can calculate the final motion vector v′, using the respective motion vectors v_{z}, v₀ to v₈ estimated from the motion vector estimation part 312, and the weights corresponding to the respective motion vectors v_{z}, v₀ to v₈ calculated from the weight calculation part 324. That is, the final motion vector calculation part 326 can calculate the final motion vector v′ according to Equation 6.

$${v}^{′} = {\sum }_{i = 0}^{M} {w}_{i} {v}_{i} \qquad [ Equation 6 ]$$

Referring to Equation 6, wᵢ is a weight corresponding to the motion vector vᵢ, and v′ is the final motion vector. In particular, the final motion vector calculation part 326 can multiply the weights corresponding to the respective motion vectors v_{z}, v₀ to v₈ by the respective motion vectors v_{z}, v₀ to v₈, and can generate the final motion vector v′ by adding all the multiplied values. The generated final motion vector v′ is provided to the motion compensation part 330.

The motion compensation part 330 can perform motion compensation in a frame/field to be interpolated, using the final motion vector v′ inputted from the final motion vector calculation part 326, and can generate a pixel f to be interpolated.

Meanwhile, according to this embodiment, the motion compensation apparatus 300 using a motion vector can estimate and compensate motions more correctly by using blocks of different sizes in estimating and compensating the motions. That is, it is an aspect that the motion estimation is performed in a larger block, and the motion compensation is performed in a smaller block.

For example, when there are a 16×16 block and a 8×8 block, it is an aspect of the general inventive concept, for corrector estimation, to estimate the motion vector using the 16×16 block rather than to use the 8×8 block. On the other hand, if the 8×8 block is used for motion compensation, a motion vector which is inaccurately estimated looks relatively smaller, and therefore, almost no block artifacts phenomenon occurs. Accordingly, when the motion estimation part 310 estimates the motion vector in the 16×16 block, and the motion compensation part 330 compensates the motion vector in the 8×8 block, the number of the estimated motion vector grows four times. Therefore, a vector density of the motion vector field is improved, and thus, image quality is improved.

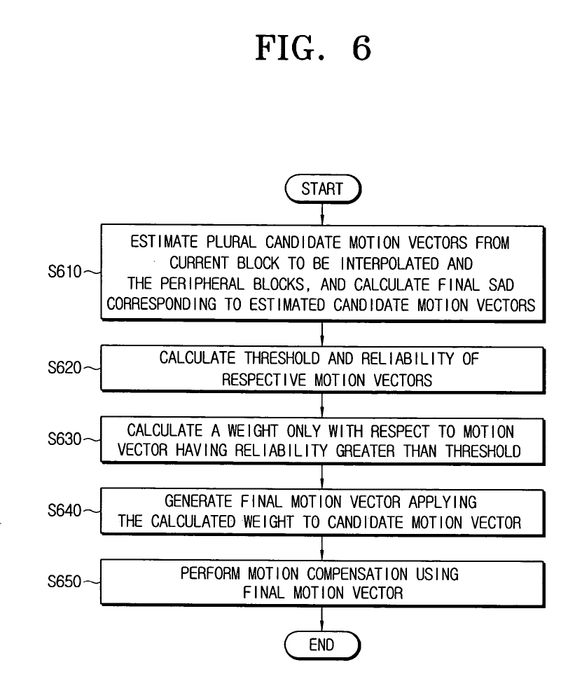

FIG. 6 is a flowchart schematically illustrating the motion compensation method that can be used with the motion compensation apparatus shown in FIG. 3 according to another embodiment of the general inventive concept.

Referring to the method of FIG. 3, first, the motion vector estimation part 312 divides the current frame/field (Fₙ) into a plurality of blocks, and then calculates the SAD with respect to the divided blocks using the BMA. Next, the motion vector estimation part 312 estimates the motion vector, considering the current block B₀ to be interpolated and the peripheral blocks B₁ to B₈ first, among the divided blocks.

The motion vector estimation part 312 estimates the motion vectors v₀ to v₈ of the respective blocks B₀, B₁ to B₈ to be interpolated from the position having the minimum SAD among the plurality of SAD calculated with respect to the respective blocks B₀, B₁ to B₈ to be interpolated. In addition, the motion vector estimation part 312 estimates a zero motion vector v_{z} where the motion vector of the current block B₀ is zero.

After the respective motion vectors v_{z}, v₀ to v₈ are estimated, the motion prediction error calculation 314 calculates the SAD corresponding to the estimated motion vectors v_{z}, v₀ to v₈ (S610). At this time, the motion vectors v_{z}, v₀ to v₈ estimated with respect to the respective current block B₀ to be interpolated and the peripheral blocks B₁ to B₈, are designated as the candidate motion vector of the current block B₀.

When the operation S610 is completed, the reliability determination part 322 calculates the reliability of the respective motion vectors v₀ to v₈ using Equation 3, and compares with the preset threshold in operation S620. In the operation S620, the reliability determination part 322 supplies a selective signal to the weight calculation part 324, the selective signal to apply the weight only to motion vectors which satisfy Equation 3.

Further, when the selective signal is provided, which enables only a predetermined motion vector which has the reliability greater than the threshold among the motion vectors v₀ to v₈ to be applied to the weight, the weight calculation part 324 calculates a weight to apply to a motion vector which has the selective signal ‘1’, using Equation 4 in operation S630.

When the weight with respect to the respective motion vectors v₀ to v₈ are calculated, the final motion vector calculation part 326 generates the final motion vector using the calculated weight in operation S640. The motion compensation part 330 performs motion compensation using the calculated final motion vector in operation S650.

According to the above motion compensation apparatus 300 of FIG. 3 using the described motion vector, and the method thereof, in performing the motion compensation of the blocks to be interpolated, the motion vectors v₁ to v₈ of the peripheral blocks B₁ to B₈ as well as the motion vector v₀ of the current block B₀ are used. That is, after an SAD is calculated in the respective motion trajectories using the motion vectors v₀ to v₈ of the current block B₀ and the peripheral blocks B₁ to B₈, the weight is calculated using the SAD.

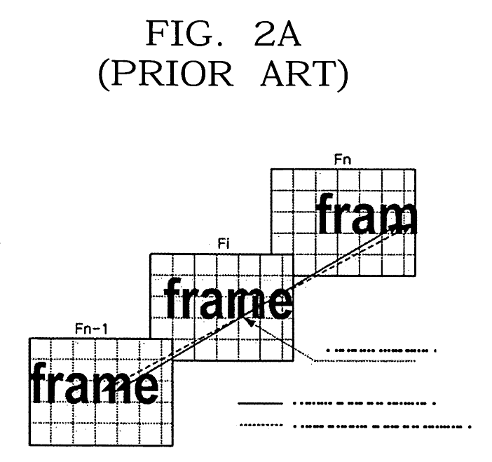

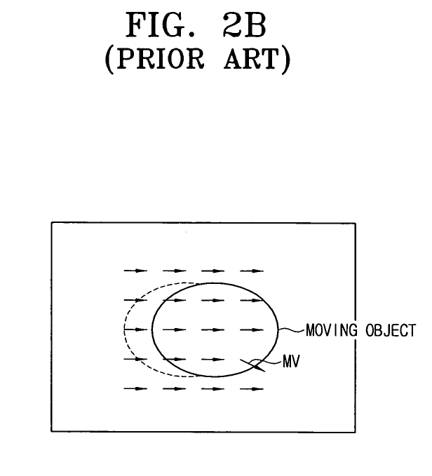

Further, the block artifacts caused mainly due to the inaccurate estimation of the motion vector v₀ of the current block B₀, as shown in FIG. 2, can be prevented by applying the weight which is inversely proportional to the calculated SAD.

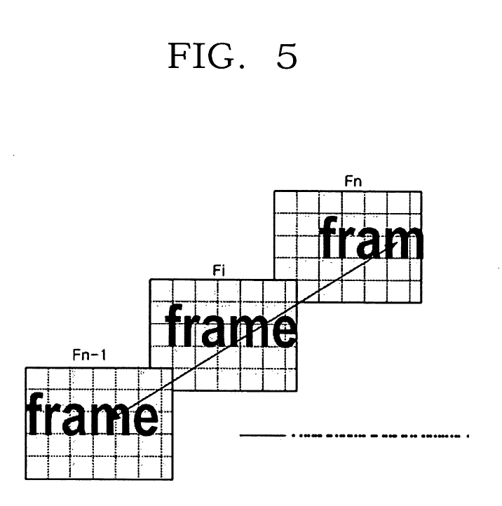

That is, according to the motion compensation apparatus 300 of FIG. 3 described so far, the final motion vector v′ is generated, considering the plurality of motion vectors v_{z}, v₀ to v₈ per block to be interpolated, based on an assumption that motions between blocks are smooth, and the motion compensation is performed using the generated final motion vector v′. Therefore, in an image outputted from the motion compensation apparatus 300 using the motion vector, according to the present invention, the block artifacts phenomenon is removed or reduced, as shown in FIG. 5.

As described above, the motion compensation apparatus 300 of FIG. 3 using the motion vector, and the method thereof, as illustrated in FIG. 6, estimates not only the motion vector of the current block B₀, but also the motion vector of the peripheral blocks B₁ to B₈ adjacent to the current block B₀, and applies the estimated motion vectors for the candidate motion vector of the current block B₀. Additionally, the motion compensation apparatus generates the final motion vector by adaptively allocating the weight to at least one candidate motion vector, and performs the motion compensation. Accordingly, by performing the motion compensation considering the plurality of the candidate motion vectors, the block artifacts, which is caused by an inaccurate estimation of the motion vector of the current block B₀, can be prevented or reduced. In addition, hardware can be more simply structured since all the motion trajectories which can be considered for a plurality of motion vectors are applied without requiring additional processes.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A motion vector generation apparatus, comprising:
a weight calculation part that adaptively calculates a predetermined weight to apply to at least one of respective candidate motion vectors which are estimated to compensate the current block to be interpolated; and
a final motion vector calculation part that adaptively generates a final motion vector by allocating the calculated weight to at least one of the candidate motion vectors corresponding to the calculated weight;
wherein the generated final motion vector is used for motion compensation of the current block.

2. The motion vector generation apparatus of claim 1, wherein at least one of the candidate motion vectors includes a motion vector estimated from the current block and motion vectors estimated from at least one of peripheral blocks adjacent to the current block.

3. The motion vector generation apparatus of claim 2, wherein the weight calculation part determines the accuracy of the estimated candidate motion vectors by comparing final motion prediction errors corresponding to the respective candidate motion vectors, and calculates the weight to allocate to the candidate motion vectors according to the accuracy as determined, and
at least one of the candidate motion vectors is a vector estimated from a position corresponding to the minimum value among a plurality of motion prediction errors calculated by applying a block matching algorithm with respect to the current block and the respective peripheral blocks.

4. The motion vector generation apparatus of claim 3, wherein the weight is inversely proportional to the final motion prediction error calculated with respect to the current block and the respective peripheral blocks.

5. The motion vector generation apparatus of claim 3, wherein the motion prediction error is calculated by at least one of a sum of absolute difference (SAD) and a mean absolute difference (MAD).

6. The motion vector generation apparatus of claim 1, wherein the sum of the weights corresponding to the respective candidate motion vectors calculated from the weight calculation part is 1.

7. The motion vector generation apparatus of claim 1, wherein the final motion vector calculation part calculates the final motion vector according to the following Equation:
$${v}^{′} = {\sum }_{i = 0}^{M} {w}_{i} {v}_{i}$$
where vᵢ is the at least one candidate motion vector, wᵢ is a weight applied to vᵢ, and v′ is the final motion vector.

8. The motion vector generation apparatus of claim 1, further comprising a reliability determination part to calculate a reliability for determining whether the respective candidate motion vectors are used during generation of the final motion vector, and providing a selective signal to the weight calculation part, the selective signal which enables only a predetermined candidate motion vector which has the reliability larger than a preset threshold, among the at least one candidate motion vector to be applied with the weight.

9. The motion vector generation apparatus of claim 8, wherein the reliability is calculated by the following Equation:

|Φ(ν_{z})−Φ(νᵢ)|<ε_{T}, i=0, 1, 2, . . . , M
where Φ(ν_{z}) is a motion prediction error corresponding to the zero motion vector, Φ(νᵢ) is a motion prediction error corresponding to the candidate motion vectors, and ε_{T} is the threshold.

10. A method of generating a motion vector, the method comprising:
adaptively calculating a predetermined weight to allocate to at least one candidate motion vector, respectively, for compensation of a current block to be interpolated; and
adaptively generating a final motion vector by allocating the calculated weight to at least one of the candidate motion vectors corresponding to the calculated weight,
wherein the generated final motion vector is used for motion compensation of the current block.

11. The method of generating a motion vector of claim 10, wherein at least one of the candidate motion vectors includes a motion vector estimated from the current block and motion vectors estimated from at least one of peripheral blocks adjacent to the current block.

12. The method of generating a motion vector of claim 11, wherein the weight calculating operation determines the accuracy of the estimated candidate motion vectors by comparing final motion prediction errors corresponding to the respective candidate motion vectors, and calculates the weight to allocate to the candidate motion vectors according to the accuracy as determined, and
at least one of the candidate motion vectors is a vector estimated from a position corresponding to the minimum value among a plurality of motion prediction errors calculated by applying a block matching algorithm with respect to the current block and the respective peripheral blocks.

13. The method of generating a motion vector of claim 12, wherein, in the weight calculating operation, the weight is inversely proportional to the final motion prediction error calculated with respect to the current block and the respective peripheral blocks.

14. The method of generating a motion vector of claim 10, wherein the sum of the weights corresponding to the respective candidate motion vectors calculated from the weight calculation is 1.

15. The method of generating a motion vector of claim 10, wherein the final motion vector calculating operation calculates the final motion vector according to the following Equation:
$${v}^{′} = {\sum }_{i = 0}^{M} {w}_{i} {v}_{i}$$
where vᵢ is the at least one candidate motion vector, wᵢ is a weight applied to vᵢ, and v′ is the final motion vector.

16. The method of generating a motion vector of claim 10, further comprising a reliability calculating operation to determine whether the respective candidate motion vectors are used during generation of the final motion vector, and to provide a selective signal to the weight calculation part, the selective signal which enables only a predetermined candidate motion vector which has the reliability larger than a preset threshold, among the at least one candidate motion vector to be applied with the weight.

17. The method of generating a motion vector of claim 16, wherein the reliability is calculated by the following Equation:

|Φ(ν_{z})−Φ(νᵢ)|<ε_{T}, i=0, 1, 2, . . . , M
where Φ(ν_{z}) is a motion prediction error corresponding to the zero motion vector, Φ(νᵢ) is a motion prediction error corresponding to the candidate motion vectors, and ε_{T} is the threshold.
